(19) United States
(12) Patent Application Publication
(10) Pub. No.: US 2008/0032800 A1
(43) Pub. Date: Feb. 7, 2008

(54) PORTABLE POKER GAMING SYSTEM

(76) Inventors: Tom Y. Liu, Walnut, CA (US); David Liu, Walnut, CA (US)

Correspondence Address: SHELDON MAK ROSE & ANDERSON PC, 100 East Corson Street, Third Floor, PASADENA, CA, 91103-3842, US

(21) Appl. No.: 11/756,518

(22) Filed: May 31, 2007

Related U.S. Application Data
(60) Provisional application No. 60/803,533, filed on May 31, 2006.

(51) Int. Cl. A63F 13/00

(52) U.S. Cl. 463/42

(57) ABSTRACT

A device which allows an individual to play poker with other, remotely located individuals over a network, the device comprising two screens and a game console. A top screen on the device is positioned over a bottom screen and is adapted to slide or fold open to allow viewing of the bottom screen. The device includes memory and software installed on the device in order to allow game play. The software can enable the display of avatars which exhibit alternative facial or other features that display emotion and that are selected by a user. Also included is a system which enables remotely located individual users of the gaming device to engage in gaming together.

### CROSS-REFERENCE TO RELATED APPLICATION

The present Application claims the benefit of priority of U.S. Provisional Patent Application No. 60/803,533, titled “Portable Poker Gaming System,” filed May 31, 2006, the contents of which are incorporated in this disclosure by reference in their entirety.

### BACKGROUND

There are many online games that can be played using a computer system coupled to a communication network (e.g., the Internet). These games can include traditional games of chance, games of skill, and casino-type games, among others. Multiplayer games which can be played online have become particularly popular in recent years. Unlike conventional single-player electronic games, multiplayer online games enable a player to interact with other players of such games. The multiplayer aspect of these games adds to the players' gaming experience by offering new gaming considerations, including strategy and rivalries.

Online games played with a personal computer can incorporate animation and graphics which enhance the playing experience, due to the memory and processing capabilities of personal computers, which can store and run software that enables such capabilities. Online games can also be performed with other devices capable of communicating over a network, such as cell phones. While such devices can provide enhanced portability, they suffer from limited processing, memory, and display capabilities, and therefore limited abilities to provide a satisfactory gaming experience.

### SUMMARY

The present invention comprises a portable gaming device and a gaming system which makes use of this device. This gaming device, comprising two screens and a game console, allows an individual to play a game, e.g. poker, with other, remotely located individuals over a network. A top screen on the device covers a bottom screen and is adapted to slide or fold open to allow viewing of the bottom screen. During game play, the top screen can display information relating to a game in progress, such as player identifiers, player positions and card information, while more detailed information (game results, player actions) can be displayed on the bottom screen. The top screen can display additional features (such as time, calendar, and/or an alarm) when in the closed position, but operates together with the bottom screen to enable game play when open.

The console of the device includes controls adjacent to the bottom screen for operating the device. The controls can be covered by the top screen in the closed position, or can remain available by being positioned adjacent the closed top screen. Two sets of controls, one located on each lateral side of the bottom screen, are preferably included for easier two-handed operation. The device further includes a processor or controller, memory in communication with the processor, and software installed on the device in memory in order to allow faster game play. The software can enable the display of avatars which exhibit alternative facial or other features that display emotion or otherwise interact with the avatars of other users.

### DRAWINGS

These and other features, aspects and advantages of the present invention will become better understood with regard to the following description, appended claims, and accompanying figures where:

FIG. 1 is a top plan view of a gaming device of the present invention in which the upper screen is closed.

FIG. 2 is a top plan view of the gaming device of FIG. 1 in which the upper screen is open.

FIG. 3 is a front plan view of an alternative embodiment of a gaming device of the present invention.

FIG. 4 is a left side perspective view of the embodiment of FIG. 4.

FIG. 5 is a front perspective view of the embodiment of FIG. 4.

FIG. 6 is a flow chart illustrating the flow of information in the present gaming system.

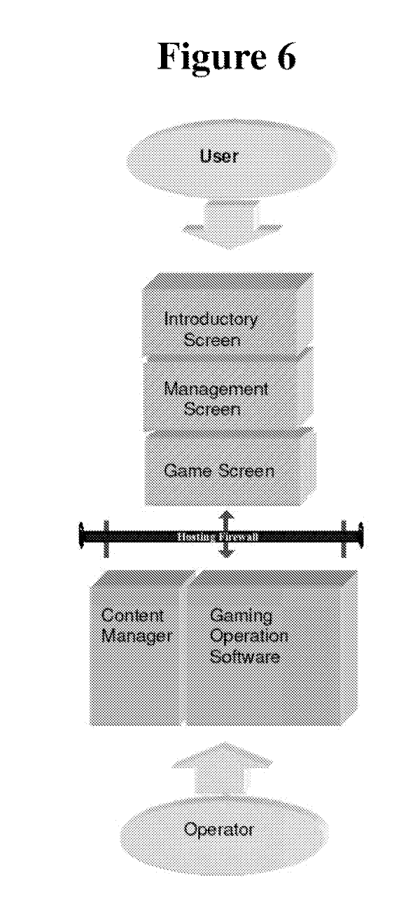

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by their intended use.

### DESCRIPTION

Definitions

As used herein, the following terms and variations thereof have the meanings given below, unless a different meaning is clearly intended by the context in which such term is used.

“Cards” refer to virtual representations, in graphic, text, or other form, of playing cards. A “standard deck of playing cards” refers to a collection of fifty-two (52) playing cards comprising four (4) sets of cards identified by the characters 2 through , jack (“J”), queen (“Q”), king (“K”), and ace (“A”). Each of the four (4) sets of cards is differentiated by one of four (4) suits, namely, a spade (“s”), club (“c”), heart (“h”), or diamond (“d”). One or more jokers or deuces can also be included in such a deck for use as the highest card or as a wild card. An “infinite” deck of playing cards refers to a deck wherein any single playing card can be dealt a repeated number of times.

“Game” and “gaming” refer to wagering activity whereby a player posts consideration, usually monetary in form, in exchange for a chance at winning a payout (which is typically a monetary payout).

“Hand” refers to a set of cards held by a single player.

“Memory” refers to information storage media accessible by the processor of a gaming device, such as RAM, PROM, EPROM, FLASH-EEPROM, and/or other forms of memory.

“Payout” refers to the compensation provided to a game player in connection with game play.

“Poker” refers to a card game in which players with fully or partially concealed cards make wagers in rounds into a central pot and/or with each other in side pots. Pots are awarded to the respectively vying players who hold the best combination of cards as determined by a predetermined hierarchy of rankings of such card combinations.

“Populating” refers to the process of adding cards to a player's hand during a game, and/or to providing a remainder of cards from which additions to the player's hand can be drawn.

“Processor” refers to circuitry that controls the operation of at least a portion of the present gaming device and which transfers data between the controller and one or more peripheral devices.

A “session” of game play is a gaming event with a beginning and an end that can encompass one or more rounds of game play. The end of a session can be determined voluntarily (when a player elects to stop play) or involuntarily (when a gaming device or dealer terminates play).

“Wireless” refers to an electromagnetic transmission medium, formatted according to any of a number of formats, standards or protocols such as Bluetooth, TDMA, CDMA, 3G or Wi-Fi. Transmission media can include radio frequency (RF) and infrared (IR) data communications.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

Gaming Device

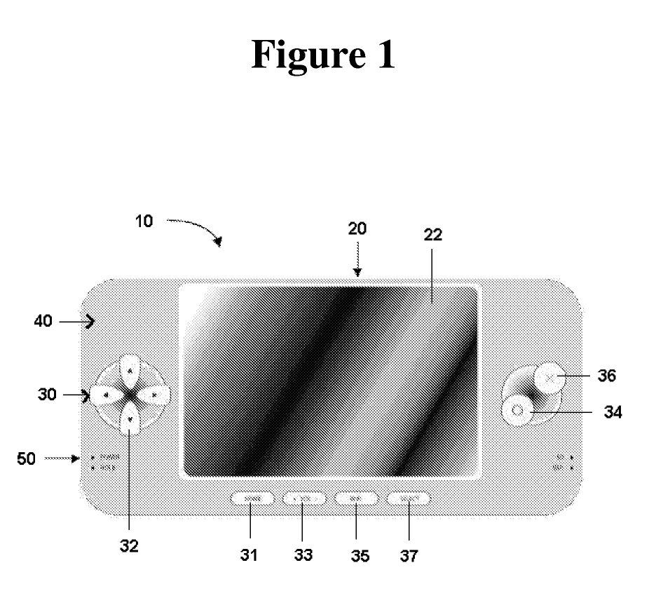

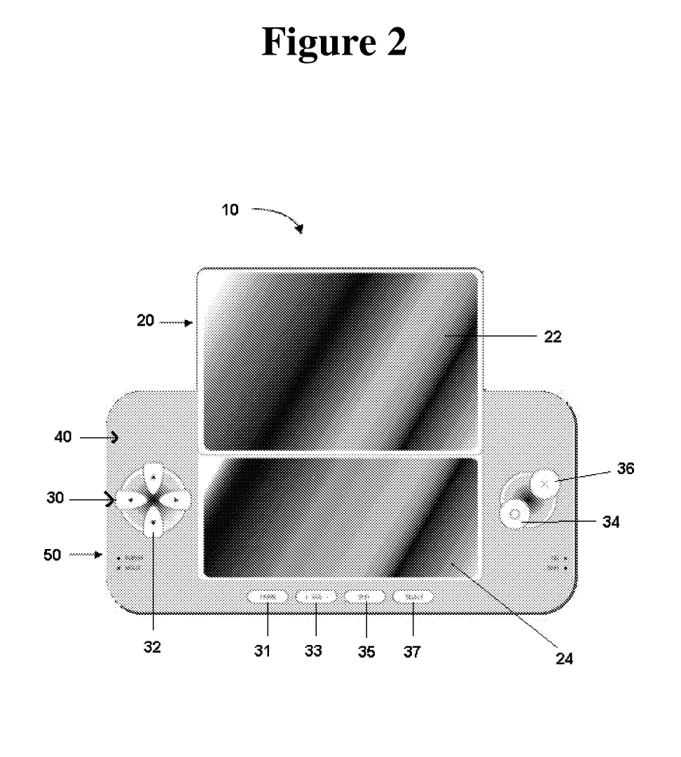

In one embodiment, the present invention comprises a gaming device 10 as shown in FIGS. 1 and 2. Such devices allow a user to engage in interactive gaming with other, remotely located individuals over a network. In particular, these devices 10 are portable and preferably allow wireless communication with the network, so that users can engage in gaming in locations of their choice.

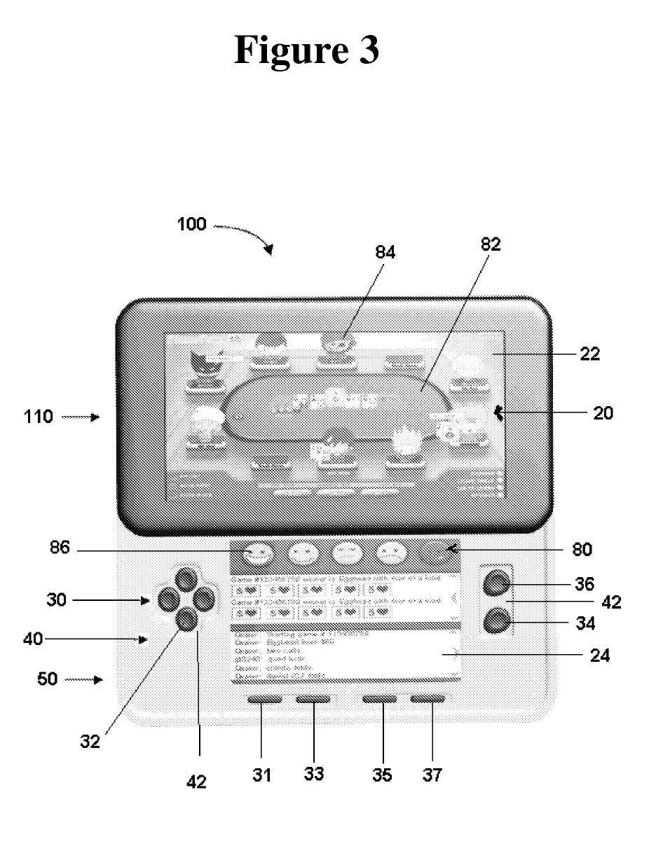

As shown in FIGS. 1 and 2, such devices 10 generally comprise display screens 20, controls 30 on a console 40, circuitry and other electrical components for executing operating and gaming instructions, and a housing 50 for such components, as described in further detail below. The device 10 can also include other controls for power (on/off), selection of wireless access format (e.g., Wi-Fi or 3G), a battery access panel, and input slots or jacks 60 for power cords, wired communication access (e.g., USB ports), SIM cards, memory cards, and/or a microphone. An alternative embodiment of the present device 100 is illustrated in FIGS. 3-5.

Processor

The software and/or other instructions included in the gaming device for enabling game play are under the control of one or more processors (e.g., microprocessors), such as Intel PENTIUM™ processors. Such processors receive instructions from a memory or like device and execute those instructions. In some embodiments, hard-wired circuitry can be used in place of or in combination with software instructions for implementing the gaming actions described herein.

The processor or processors of the present device are in operative communication (generally electrical communication) with other device components, including input devices. In the illustrated embodiments, the input devices include arrow buttons 32 for directing a cursor and buttons for selecting an item (34, 37) and for exiting a program or displayed window (34). Other input devices operable with the present gaming device can include, for example, a scroll button, a keyboard, a mouse or other pointing device, a knob or a switch (including an electronic representations of a knob or a switch), a docking station, and/or a touch screen. Such an input devices can be used, for example, by a player to play a game (e.g., by manipulating a pointer).

The processor is also in communication with one or more output devices. The output devices include one or more display screens 20, but can alternatively or in addition include a speaker and/or a printer. Output devices can provide game and other information to a player, for example.

The processor is in communication with memory as well. Such memory can comprise any appropriate information storage medium or combination of media, including magnetic, optical, and/or semiconductor memory such as Random Access Memory (RAM) and Read Only Memory (ROM). The memory of the present device preferably stores a program for enabling game play, so that instructions from the program can be executed by the processor rather than received over a communications network, thereby enabling faster display response and an enhanced gaming experience.

The processor is further coupled to a communication device for communicating via a communication network. While the device can include circuitry to allow communication with such a network via wired access (e.g., telephone or cable lines), the device preferably includes electronic components which enable wireless communication with such a network.

In addition, the processor can include or otherwise be in operative communication with a random number generator configured to generate random or a pseudo-random numbers. Random number generation can be used, for example, to determine a random selection of cards to form a playing card hand or the position of a playing card within a hand. Alternatively, a random number generator can be implemented in software, and random numbers can be generated by the processor when implementing such software instructions.

Memory

The memory of the present device can comprise one or more memory devices or formats such as semiconductor (RAM, PROM, EPROM, FLASH-EEPROM), magnetic, and/or optical memory. Such memory preferably contains at least a program with operating instructions for the processor to enable gaming with the present device. The program can be stored in a compressed, uncompiled and/or encrypted format, and can include other program elements, such as an operating system, a database management system, and/or device drivers used by the processor to interface with peripheral devices (e.g., input and output devices).

Display Devices

The display devices used with the present gaming device can comprise, for example, one or more display screens 20 or areas for outputting information related to game play on the gaming device, such as a liquid crystal display (LCD) screen. Display devices provide information to the user and enable the user to engage in gaming and to communicate with the gaming system.

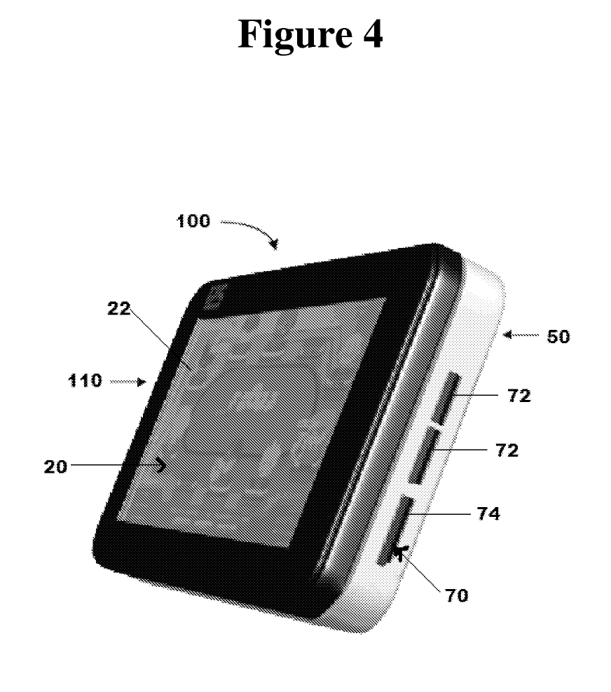

In preferred embodiments, as shown in FIGS. 1-5, the present gaming device comprises more than one screen or display device. In these embodiments, an upper screen 22 is foldably (i.e., hingedly) or slidably movable with respect to a lower screen 24, such that in a first (closed) position the upper screen 22 covers and protects the lower screen 24 (as shown in FIGS. 1 and 4), while in a second (open) position the lower screen is visible and/or accessible to a user (as shown in FIGS. 2, 3, and 5). In slidable embodiments, the cover comprises tracks or grooves which mate with complementary grooves or tracks on the housing 50. The use of two screens not only enlarges the visible area on which information can be displayed, but also allows the two screens to display different information to a user. For example, the upper screen 22, when in an open position, can display game play information while the lower screen 24 displays game statistics or other information of interest to the user. The upper screen 22 can, in one embodiment, be operable via a touch-screen, in this way allowing the device 10 to be operated when the upper screen 22 is in the closed position.

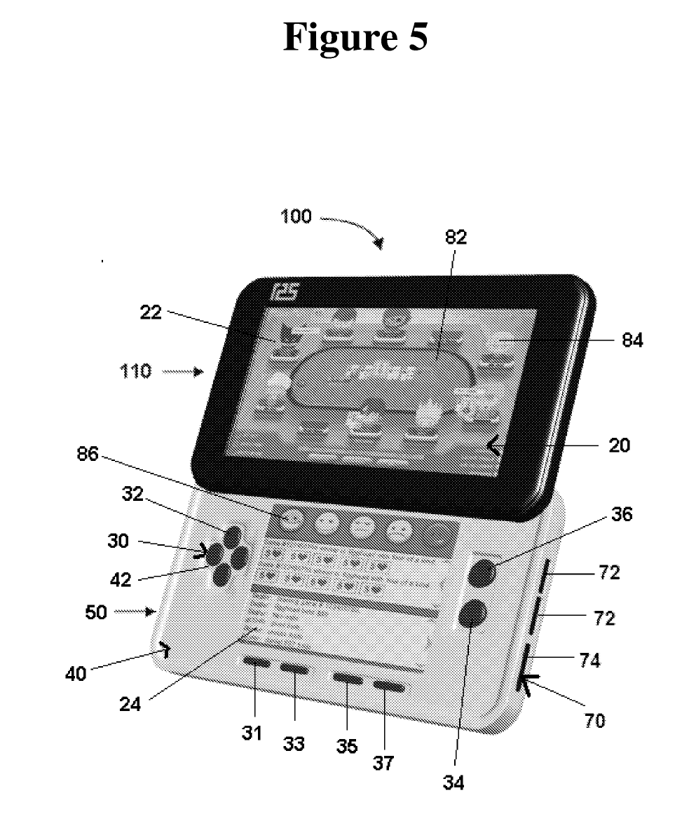

The embodiment of FIGS. 1 and 2 differs from the embodiment of FIGS. 3-5 in that the upper screen 22 in the embodiment of FIGS. 3-5, when in a closed position, covers game and other console controls 30, thus preventing their inadvertent activation. In this embodiment, the upper screen 22 is present in a cover 110 which can be closed over the console 40. Preferably, the console 40 is provided with recesses 42 for containing the controls 30, as shown in FIGS. 3 and 5. In the embodiment of FIGS. 1-2 on the other hand, information on the upper screen 22 can be manipulated with available controls 30 while the upper screen 22 is in the closed position.

In addition to serving as output devices, display devices can in some embodiments also serve as input devices. For example, a gaming device can comprise an LCD display for displaying information as well as for selecting information (i.e. via “touch-screen” technology).

Console

The console 40 of the present gaming device includes controls 30 for inputting information to enable game play and communication with the gaming system, and can also include controls 30 for other functions such as an on/off switch. Each control 30 for game play is accessible to a player during gaming.

In the embodiments of FIGS. 1-5, controls 30 are located adjacent the lower screen 24 on either lateral side of the lower screen. In this way the gaming device can be gripped or cradled in both hands of a user, and the user's thumb or other fingers of each hand can be used to input information and/or take other actions with respect to a game or the gaming system. The controls accessible on each lateral side of the lower screen 24 include cursor controls 32 and buttons to select items (34) and to cancel selections or exit a window or program (36).

Other control buttons can also advantageously be included on the console in order to enable additional functions or for ease of use. In the embodiments of FIGS. 1-5, additional control buttons are provided below the lower screen 24. These buttons can, for example, be assigned to functions such as returning to a “home” screen 31, volume control 33, WiFi enablement 35, and “select” 37, though other functions can be assigned to such buttons. Additional or fewer buttons are also possible in other embodiments.

Other Components

The present gaming device can be provided with other components as well. For example, the device can include a connector in order to place the device in communication with the network server via a USB or other wired connection. However, the device is preferably operable by a wireless connection, and is provided with devices or other components, such as a Wi-Fi transceiver, to enable wireless communication. In a preferred embodiment, the present gaming devices are equipped to communicate wirelessly by two or more wireless means. For example, the device can be configured to access the Internet via both a Wi-Fi and a GSM connection, so that a user can make use of a Wi-Fi connection when possible and avoid telephone connection charges, but have the option of connecting by a GSM connection when a Wi-Fi connection is not available, or otherwise at the user's option.

Other input devices can also be used in connection with the present gaming device. Such other input devices include: a bar-code scanner, a magnetic stripe reader, a keypad, a microphone, an infrared sensor, a voice recognition module, a video camera, a digital camera, a network card, a universal serial bus (USB) port, a GPS receiver, and an infrared port. In the embodiment shown in FIG. 4 additionally shows ports 72 for inserting one or more SIM (subscriber identity module) cards and a port 74 for a memory card.

Game System Operation

In the present system, a portable gaming device is used to engage in gaming with other players by means of a network. One or more network servers, such as an IBM RS 60 or the like, can serve as the game server for linking a plurality of portable gaming devices to each other and thereby enable group play. A data communications system, which can take the form of a local or wide area network, preferably links the gaming devices to the server via the Internet (TCP/IP).

When the present gaming device is placed in communication with a game server, the user can be identified by information previously stored in the memory of the device. Preferably, however, a password or other security protocol is provided prior to granting access to the user to a game in order to ensure the identity of the user.

In a preferred embodiment, a user is initially presented with a home page or other introductory screen when first placed in communication with the game server. Such an introductory screen can include information which introduces the gaming system, links to screens which allow registration of a new user, links to banking and other online services for establishing a financial account with the operator of the gaming system, and other informational resources. The introductory screen can further provide information about the various games, in particular poker games, offered by the gaming system and the rules for such games. For the convenience of players, access to the game server via a different device, such as a home computer, can be implemented via an Internet connection, and the introductory screen described above can be provided as the home page through which the user gains access to gaming through the game server.

Once registered, a user is presented with a management screen on which the user can view the games available to be joined and can select which game the user would like to join. Information necessary to join a game in progress, such as the buy-in necessary to join the game, would also preferably be provided on this screen. This screen can also allow the user to manage his profile and account, log out, and provide other options. Such other options can include e-mail to a support contact for account issues, a “buddy list” of other registered users currently playing that the individual enjoys playing with, a personal hand history, and a change/update password and/or screen name feature. A “create private games” feature can also be provided to allow a player to create a private game (a virtual “table”) to host a game with his buddies or any other closed group of registered users.

Once a particular game is selected by the user, the user is taken to a game screen where other players play a game and wager money. This section of the gaming interface provides the primary graphic interface for game play. With this interface, the player interacts with other players, joins play, and wagers. In a preferred embodiment, the game provided by the gaming interface is a poker game, in which case the game screen can present graphics or images 80 such as a virtual table 82 showing representations of other users positioned around it. The table 82 can rotate to show players as they have their turns, and then when the hand is down to a few players, it can be configured to show only those players remaining, or can provide a separate screen showing only those players. In this embodiment, tables generally will accommodate between 6 and 10 players, depending upon the game format.

In a preferred embodiment, as shown in the upper screen 24 of the device 100 in FIGS. 3-5, the players in a game are also represented by a graphical image, referred to herein as an avatar 84. The avatar 84 can be any graphical image provided by the gaming system or otherwise provided by a user, but is preferably an anthropomorphic image which displays facial expressions or other indicators of emotion. In an especially preferred embodiment, the gaming system is configured so that avatars 84 take on a particular expression indicative of a human emotion or reaction, such as happiness, sadness, or anger, upon the occurrence of a particular event. For example, a player's avatar 84 can express an angry expression when the player loses a game. The system can also make avatars 84 interact in other fashions upon the occurrence of a triggering event.

More preferably, users of the present system can choose from a selection of reactions or expressions which their avatars 84 will undertake upon the occurrence of a triggering event. For example, as shown in FIGS. 3 and 5, the lower screen 24 can be configured to display graphical images 86 representative of different reactions which the avatars 84 are capable of expressing. The avatars 84 can then be made to display an emotion or reaction by selecting one of the graphical images 86, in addition to or instead of reactions which are displayed under the control of the gaming system upon the occurrence of predetermined triggering events. Avatar reactions can also be commanded via the selection of displayed text or in other manners.

The use of avatars capable of expressing an emotion or reaction can help to personalize a player's online gaming experience by allowing the player to express feelings to other players and also to experience personalized reactions from other players. Such interaction can enhance the gaming experience, though it is contrary to the tenets of “traditional” competitive gaming, in particular poker play, in which the norm is to minimize communication in order to hide any behavioral artifacts that could provide information regarding the strength of a player's hand or how a player is likely to play. Such expression by avatars 84 can include facial animation, and can also be coupled with sound clips associated with a wide range of reactions.

The present gaming system further comprises game operating software residing on the network server or servers which manages game play and financial transactions. This software provides game logic for playing games, for example poker games such as Texas Holdem, Omaha, Omaha Hi/Lo, 7 Card Stud, 7 Card Stud Hi/Lo. Such logic further allows for play by a user in a single game or table, in multiple games, in tournaments, and in games without money wagers.

The game operating software preferably is capable of detecting the absence of a player (i.e., no longer logged in, or not responding within a predetermined amount of time to a turn) and of allowing extra time for the player to reconnect and play a hand. In one embodiment, if a player runs out of extra time, the server can dip into a “disconnection protection” pool of credits assigned to the player. Such credits operate like “get-out-of-jail-free cards,” such that when a player has one, the dealer declares the player as “all-in” for the duration of the hand (even though the player is not technically all-in because the player still has chips). In this case the player's hand will compete for the main pot, which is determined as of when the player's absence is detected, while the remaining players compete for the wagers made following such detection, in effect a “side pot.”

The gaming system preferably makes use of random number generation (RNG) in order to assure fair game play. RNG logic produces numbers (or a stream of numbers) which cannot be predicted using available data. Such logic can be applied, for example, to the virtual shuffling of cards for a game. Positive measures for detecting and preventing cheating can also be taken to assure fair game play, including the following: detecting communication and collaboration of players that are sitting at the same table and communicating with each other, such as via Internet chat, VoIP or telephone; hand analytics, to determine whether a player would have a too favorable hand to drop out early in a game or stay raising the pot with an obviously bad hand; monitoring of hours played; the use of foreign country filters to block certain IP addresses in cases where cheat attacks are discovered coming primarily from one country; using single IP address filters, to block addresses of users identified as cheating risks; IP comparison and analysis, to determine whether two parties are in the same room and are collaborating with each other through information exchange by singling out IP addresses that are close to each other when people are playing at the same table; offering rewards to other players to inform the game operators about suspicious behavior and reward them for doing so; analyzing the biggest winners (sessions, daily, weekly, monthly); and IP spoof detection, i.e. detection of IP addresses made to appear different from what they really are. Other security and fair play features can include disconnect protection, to protect users so that other players don't drop offline on purpose when it is convenient for them.

Content manager software is also preferably used to control what information is shown on users' screens. This information can include all the text on the web pages, gaming options, player registrations, and other content on the screen except for the actual “live play” data.

Game Play Features

The games playable with the present system, in particular poker games, can include additional features which enhance the gaming experience. One such feature is extra thinking time on big pots. For example, a player can be given 7 extra seconds to decide whether he wants to continue to bet on the current pot or fold. This option is offered when a pot reaches a certain predetermined threshold.

Extra time to buy more chips if a player goes broke in a cash game can also be offered. To accommodate player that runs out of chips during a game, the player can receive a 60 second break in order to be able to obtain further credits for wagering in a game.

At the end of each game, an animation showing the winning hand to the other players can be displayed. For example, low hands can be shown with yellow color in Hi/Lo games.

Player notes can also be offered as a feature. A poker enthusiast, for example, can post comments, remarks or just reminders of past games to a certain player. These notes are not seen by the other players. Such personal notes can be distributed to the intended recipients privately, and can be saved and shown every time a player sits at a table with that person,

Post game analytics/statistics can also be generated by the gaming system for players. Such statistics and analysis of games played can help to improve game play.

In addition, one or more standard decks of playing cards can be used in a single game. For example, a game can include a plurality of hands (e.g., as in Triple Play Draw Poker™ from Action Gaming™) that can be dealt from a plurality of virtual decks (e.g., each hand can be dealt from a respective deck).

### EXAMPLE 1

A portable gaming device for playing poker over a network is constructed substantially as shown in FIGS. 1 and 2. The device is approximately 5.7 in (W)×5 in (H)×0.9 in (D) and is approximately 0.8 lbs (including battery) in weight. It includes a CPU and sufficient memory to store software for operating a poker game. The display comprises dual LCD screens, and included are built-in stereo speakers as well as a headset jack. A 5V DC connector is provided for operating the device and charging the battery, and an SD memory slot is included.

The console includes directional buttons (Up/Down/Right/Left) and 2 “enter” keys located adjacent the narrower sides of the lower LCD screen. Below the lower screen are further included a SELECT button, a HOME button, and a volume button. On the sides of the device are switches to turn the power on and off as well as a Wireless LAN switch (ON/OFF). Power is supplied by a lithium-ion battery & secondary battery (for back up only). Internal components enable Wi-Fi and GSM wireless communications.

The gaming device is further provided with the following features, in addition to poker play functionality: an MP3 player, calendar, calculator, and an alarm. Software for operating the game is pre-installed in the device so that users to enjoy enhanced graphics and faster game play.

Although the present invention has been discussed in considerable detail with reference to certain preferred embodiments, other embodiments are possible. The steps disclosed for the present methods are not intended to be limiting nor are they intended to indicate that each step depicted is essential to the method, but instead are exemplary steps only. Therefore, the scope of the appended claims should not be limited to the description of preferred embodiments contained in this disclosure. All references cited herein are incorporated by reference to their entirety.

Further, although process steps, method steps, algorithms or the like can be described in a sequential order, such processes, methods and algorithms can be configured to work in alternate orders. Thus any sequence or order of steps described herein does not necessarily indicate a requirement that the steps be performed in that order, in some instances simultaneously.

What is claimed is:

1. A portable gaming device, comprising:
a cover having an upper surface, the upper surface comprising a display screen;
a housing having an upper surface, the upper surface comprising a console, the console comprising:
a lower display screen; and
one or more controls;
a processor for receiving inputs from the one or more controls and for outputting information to the lower screen and the upper screen; and
memory comprising operating instructions for the processor to enable gaming, wherein the cover is foldably or slidably movable with respect to the lower screen of the housing such that the cover provides access to the lower screen in a first position and covers the lower screen in a second position.

2. The gaming device of claim 1, wherein the upper screen is visible when the cover is in the second position.

3. The gaming device of claim 1, wherein the controls are covered when the cover is in the second position.

4. The gaming device of claim 1, wherein the cover is slidably movable with respect to the lower screen of the housing.

5. The gaming device of claim 1, wherein the cover is hingedly movable with respect to the lower screen of the housing.

6. The gaming device of claim 1, wherein when the processor is processing gaming instructions for a game and the cover is in the first position, the upper screen displays information relating to the game.

7. The gaming device of claim 6, wherein the information comprises player identifiers, player positions and card information.

8. The gaming device of claim 6, wherein when the processor is processing gaming instructions for a game and the cover is in the first position, the lower screen displays game results and player actions.

9. The gaming device of claim 1, wherein when the cover is in the second position, the upper screen displays time and date information.

10. The gaming device of claim 1, wherein the controls are accessible when the cover is in the second position.

11. The gaming device of claim 1, wherein the device comprises a first set of controls adjacent a first lateral side of the lower screen and a second set of controls adjacent a second lateral side of the lower screen.

12. The gaming device of claim 1, further comprising a wireless transceiver.

13. The gaming device of claim 1, wherein the operating instructions enable the display of a graphical image of each of a plurality of individuals playing a game.

14. The gaming device of claim 1, wherein the graphical image of each of the plurality of individuals displays a facial expression, and wherein the operating instructions enable a user of the device to change the facial expression of the graphical image.
